(19) United States
(12) Patent Application Publication
(10) Pub. No.: US 2015/0125592 A1
(43) Pub. Date: May 7, 2015

(54) MANUFACTURING METHOD OF FIBER-CONTAINING DISPERSION, CONDUCTIVE FIBER-CONTAINING DISPERSION, AND MANUFACTURING METHOD OF CONDUCTIVE LAYER

(71) Applicant: FUJIFILM CORPORATION, Tokyo (JP)

(72) Inventors: Tsuyoshi ARAI, Ashigarakami-gun (JP); Makoto KOIKE, Ashigarakami-gun (JP); Tetsuo KURAHASHI, Ashigarakami-gun (JP)

(73) Assignee: FUJIFILM CORPORATION, Tokyo (JP)

(21) Appl. No.: 14/565,570

(22) Filed: Dec. 10, 2014

Related U.S. Application Data
(63) Continuation of application No. PCT/JP2013/066361, filed on Jun. 13, 2013.

(30) Foreign Application Priority Data
Jul. 19, 2012 (JP) 2012-160668

(51) Int. Cl. B01D 37/00; C09D 5/24; H01B 13/00; B01D 39/10

(52) U.S. Cl. CPC B01D 37/00; B01D 39/10; C09D 5/24; H01B 13/0026
USPC 427/58; 210/767; 252/514

(57) ABSTRACT

A manufacturing method of a fiber-containing dispersion includes obtaining a crude dispersion 20 containing fibers 10 and removing foreign substances by passing the crude dispersion 20 through a filter medium 40. The filter medium 40 is constituted with a plate material having a plurality of opening portions 42 through which the crude dispersion 20 is passed and non-opening portions 44 which partition the plurality of opening portions 42 from one another. The filter medium 40 satisfies the following relational expressions.

½ of average major-axis length of fibers≦Minor-axis width of opening portions 42≦5 times the average major-axis length of fibers 10 (1)

Minimum width of non-opening portions 44≧Average major-axis length of fibers 10 (2)

Aperture ratio of filter medium 40≧0.9%. (3)

### CROSS-REFERENCE TO RELATED APPLICATIONS

This application is a Continuation of PCT International Application No. PCT/JP2013/066361 filed on Jun. 13, 2013, which claims priority under 35 U.S.C §119(a) to Japanese Patent Application No. 2012-160668 filed on Jul. 19, 2012. Each of the above application(s) is hereby expressly incorporated by reference, in its entirety, into the present application.

### BACKGROUND OF THE INVENTION

1. Field of the Invention

The present invention relates to a manufacturing method of a fiber-containing dispersion, a fiber-containing dispersion, and a manufacturing method of a conductive layer. Particularly, the present invention relates to a technique of efficiently and continuously removing foreign substances.

2. Description of the Related Art

ITO is being widely used as a conductive material for display devices such as a liquid crystal display and an organic EL/touch panel and for electrodes used for integrated solar cells and the like. However, ITO has problems in that the reserves of the metal indium are small; ITO exhibits a low transmittance in an area of long wavelengths and thus deteriorates transparency; thermal treatment needs to be performed at a high temperature so as to reduce resistivity thereof; and ITO does not have bending resistance. Under these circumstances, the examination of a conductive member using metal nanowires has been reported and such a conductive member is expected to become an alternative for ITO since it has excellent transparency, has low resistivity, and can reduce the amount of metal used.

Generally, in order to manufacture the conductive member of metal nanowires, a metal nanowire-containing dispersion is used. WO2009-107694A describes a dispersion manufacturing method including a step of performing cross-flow filtration of a crude dispersion in which metal nanowires have been dispersed. JP2003-300716A describes a method of classifying carbon nanotubes from carbon nanotube dispersion by centrifugation and filtration. WO2009/063744A, JP2006-040650A, and JP2009-127092A describe a method of extracting solid content from a dispersion containing metal nanowires or rod-like silver powder by filtration and purifying the solid content by re-dispersion.

### SUMMARY OF THE INVENTION

In the manufacturing method of WO2009/107694A, the pore size of the film used for the cross-flow filtration is generally 1 μm or less. Therefore, impurities that typically have a length of 1 μm or greater cannot be removed. Furthermore, since the concentration of metal nanowires changes before and after the cross-flow filtration, adjustment of the concentration is required.

Moreover, in the manufacturing method of JP2003-300716A, solid-liquid separation occurs, hence the carbon nanotubes need to be re-dispersed in a solvent. In addition, centrifugation is unproductive since it accelerates aggregation of fibrous substances. In the manufacturing method of WO2009/063744A, JP2006-040650A, and JP2009-127092A, solid-liquid separation occurs, hence the metal nanowires or the rod-like silver powder need to be re-dispersed in a solvent.

The present invention has been made in consideration of the above circumstances, and an object thereof is to provide a manufacturing method of a fiber-containing dispersion that makes it possible to continuously and efficiently remove foreign substances having a length equal to or greater than the major-axis length of the fiber, a fiber-containing dispersion, and a manufacturing method of a conductive layer.

The manufacturing method of a fiber-containing dispersion according to an embodiment of the present invention is a manufacturing method of a fiber-containing dispersion, including obtaining a fiber-containing crude dispersion, and removing foreign substances by passing the crude dispersion through a filter medium. The filter medium is constituted with a plate material having a plurality of opening portions through which the crude dispersion is passed and non-opening portions which partition the plurality of opening portions from one another, and satisfies the following relational expressions.

½ of average major-axis length of fibers≦minor-axis width of opening portions≦5 times the average major-axis length of fibers

Minimum width of non-opening portions≧Average major-axis length of fibers

Aperture ratio of filter medium≧0.9%

In the removing, the Reynolds number Re of the crude dispersion calculated by the following expression is preferably 2,300 or less.

Re=v·d/(ν·α)

ν: Average flow velocity immediately in front of filter medium (m/sec)

d: Diameter of filter medium-equipped pipe (m)

ν: Kinematic viscosity of fiber-containing crude dispersion (m²/sec)

α: Aperture ratio of filter medium (%)

The plate material is preferably constituted with a plate material having a single-layer structure.

It is preferable that the plurality of opening portions have substantially the same shape, and the shape is preferably a circle or a polygon.

The filter medium is preferably a filter medium formed by an electroforming process.

It is preferable that the plurality of opening portions have substantially the same shape, and the shape is preferably slit-like.

The filter medium is preferably a wedge wire screen.

The fiber is preferably a metal nanowire, a metal nanotube and/or a carbon nanotube.

The fiber is preferably a silver nanowire.

The crude dispersion is preferably an aqueous silver nanowire dispersion obtained by dispersing silver nanowires in an aqueous solvent.

The filter medium is preferably constituted with a plate material having undergone hydrophobizing treatment. (i.e. a hydrophobized plate material)

A conductive fiber-containing dispersion according to another embodiment of the present invention is a conductive fiber-containing dispersion obtained by the aforementioned manufacturing method of the fiber-containing dispersion, in which the number of foreign substances contained in the dispersion is less than 0.1 per 1 μL.

A manufacturing method of a conductive layer according to another embodiment of the present invention includes coating the conductive fiber-containing dispersion onto a substrate, and drying the dispersion.

According to the present invention, foreign substances can be continuously and efficiently removed.

### BRIEF DESCRIPTION OF THE DRAWINGS

FIG. 1 is a view schematically illustrating the shape of fiber.

FIG. 2 is a schematic view of the flow showing removing.

FIG. 3 is a schematic view showing the relationship between the size of a filter medium and the size of fiber.

FIGS. 4A and 4B are views showing models for calculating the Reynolds number Re.

FIGS. 5A and 5B are schematic views of a filter medium having a mesh pattern.

FIGS. 6A and 6B are schematic views of a filter medium constituted with a wedge wire screen.

FIGS. 7A and 7B are views showing models for calculating the minor-axis width of an opening portion and the minimum width of a non-opening portion.

### DESCRIPTION OF THE PREFERRED EMBODIMENTS

Hereinafter, preferable embodiments of the present invention will be described. Although the present invention will described based on the preferable embodiments, it can be modified in various ways within the scope of the present invention, and embodiments other than the present embodiments can be used. Accordingly, all kinds of modifications within the scope of the present invention are included in the claims. Furthermore, in the present specification, a range of numerical values described using “to” means a range that includes the numerical values listed before and after “to”.

(Manufacturing Method of Fiber-Containing Dispersion)

The manufacturing method of fiber-containing dispersion according to the present embodiment includes (A) obtaining a fiber-containing crude dispersion and (B) removing foreign substances by passing the crude dispersion through a filter medium. The filter medium is constituted with a plate material having a plurality of opening portions through which the crude dispersion is passed and non-opening portions which partition the plurality of opening portions from one another, and satisfies the following relational expressions.

½ of average major-axis length of fibers≦Minor-axis width of opening portions≦5 times the average major-axis length of fibers (1)

Minimum width of non-opening portions≧Average major-axis length of fibers (2)

Aperture ratio of filter medium≧0.9% (3)

According to the present embodiment, foreign substances having a length equal to or greater than the average major-axis length of the fiber can be continuously and efficiently removed. In contrast, with the cross-flow filtration, only noise particles having a size extremely smaller than a wire, a compound dissolved in a solvent, or an ionic compound can be removed, and large-sized foreign substances remain. With the cross-flow filtration, foreign substances having a length equal to or greater than the average major-axis length of fiber cannot be continuously and efficiently removed.

Moreover, according to the present embodiment, a substance having a high aspect ratio (for example, 6.6 to 30,000), such as fiber, can be passed through the opening portions of the filter medium, without clogging the opening portions or straddling and sticking in the plurality of opening portions. In addition, it is possible to raise the possibility that the filtration can be continuously performed without increasing the filtration pressure. When the minimum width of each of the non-opening portions is smaller than the major-axis length of the fiber, and the fiber is in a state in which one end and the other end thereof are being put into different opening portions respectively to the same extent (a state in which the fiber is straddling the non-opening portions), the fiber cannot move in any direction. Consequentially, with the passage of time of the filtering treatment, the amount of fiber that cannot pass through the opening portions increases, and as a result, the opening portions are clogged, and it is difficult to efficiently and continuously perform filtering.

[Fiber]

The shape of the fiber is not particularly limited, and can be appropriately selected according to the purpose. The fiber can have any shape such as a cylindrical shape, a rectangular shape, or a columnar shape having a polygonal cross-section. Typical examples of the fiber include a conductive metal nanowire. The metal nanowire preferably has a minor-axis length of 1 nm to 150 nm, more preferably has a minor-axis length of 10 nm to 50 nm, and particularly preferably has a minor-axis length of 15 nm to 25 nm. Herein, the minor-axis length refers to the average minor-axis length, and the major-axis length refers to the average major-axis length.

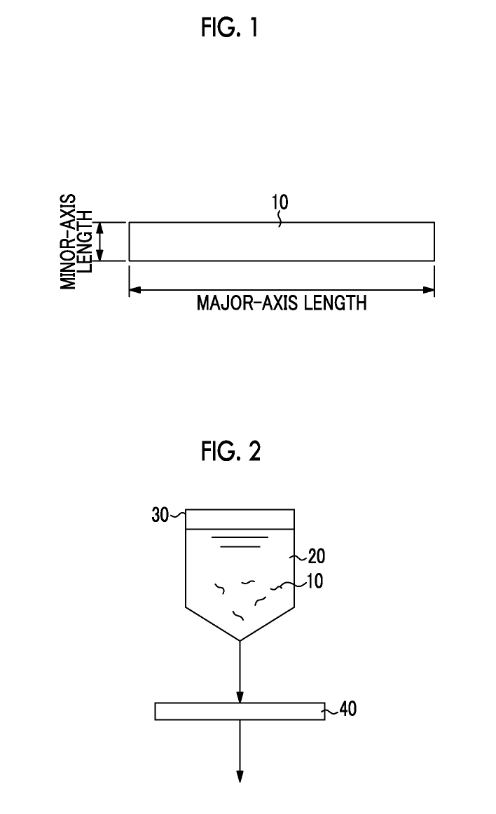

The minor-axis length and the major-axis length of the metal nanowire can be obtained in the following manner, for example. From among metal nanowires observed under magnification by using a transmission electron microscope (TEM; manufactured by JEOL Ltd., JEM-2000FX) so as to measure the average diameter (average minor-axis length) and the average major-axis length of the metal nanowires, 300 metal nanowires are randomly selected. Thereafter, the diameter (minor-axis length) and the major-axis length thereof are measured, and the averages thereof are calculated. From the thus obtained average diameter (average minor-axis length) and the average major-axis length of the metal nanowires, the minor-axis length and the major-axis length of the metal nanowire can be determined. FIG. 1 schematically shows the shape of the fiber. For example, when fiber 10 has a cylindrical shape, it has a minor-axis length and a major-axis length.

If the minor-axis length of the metal nanowire is controlled to be 1 nm or greater, it is preferable since the metal nanowire becomes resistant to oxidation. Moreover, if the minor-axis length is controlled to be 150 nm or less, it is preferable since light scattering resulting from the metal nanowire can be inhibited.

The metal nanowire preferably has a major-axis length of 1 μm to 30 μm, more preferably as a major-axis length of 3 μm to 20 μm, and particularly preferably has a major-axis length of 5 μm to 10 μm. If the major-axis length of the metal nanowire is controlled to be 1 μm or greater, it is preferable since the probability that the metal nanowires may come into contact with each other can be increased, and thus a conductive film with low resistivity is easily obtained. Furthermore, if the major-axis length of the metal nanowire is controlled to be 30 μm or less, it is preferable since the dispersion stability can be maintained.

The metal constituting the metal nanowire is not particularly limited, and can be appropriately selected according to the purpose. Examples thereof include copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, an alloy of these, and the like. Among these, copper, silver, gold, platinum, palladium, nickel, tin, cobalt, rhodium, iridium, or an alloy of these is preferable; palladium, copper, silver, gold, platinum, and an alloy of these are more preferable; and silver or a silver-containing alloy is particularly preferable.

The content of silver nanowires among the metal nanowires is preferably 50% by mass or more, and more preferably 80% by mass or more. It is even more preferable that the metal nanowires be substantially silver nanowires. Herein, “substantially” means that atoms of a metal other than silver that are inevitably mixed into the dispersion is accepted.

Examples of preferable fibers other than the metal nanowire include a metal nanotube or a carbon nanotube as hollow fiber.

(Metal Nanotube)

The material of the metal nanotube is not particularly limited, and any type of metal may be used. For example, the aforementioned materials of the metal nanowire can be used.

The metal nanotube may have a single-layered shape or a multi-layered shape. However, in view of excellent conductivity and excellent thermal conductivity, the single-layered shape is preferable.

The thickness (difference between the outer diameter and the inner diameter) of the metal nanotube is preferably from 3 nm to 80 nm, and more preferably from 3 nm to 30 nm.

If the thickness of the metal nanotube is 3 nm or greater, sufficient oxidation resistant is obtained, and if it is 80 nm or less, occurrence of light scattering resulting from the metal nanotube is inhibited.

The average minor-axis length of the metal nanotube is preferably 150 nm or less similarly to the metal nanowire, and a preferable minor-axis length thereof is also the same as that of the metal nanowire. Furthermore, the major-axis length of the metal nanotube is preferably from 1 μm to 30 more preferably from 3 μm to 25 and even more preferably from 5 μm to 20 μm.

The manufacturing method of the metal nanotube is not particularly limited and can be appropriately selected according to the purpose. For example, the method described in US2005/0056118A and the like can be used.

(Carbon Nanotube)

The carbon nanotube (CNT) is a substance in which the atomic plane of graphite-like carbon (graphene sheet) forms a single-layered or multi-layered tube around the same axis. The single-layered carbon nanotube is called a single-wall nanotube (SWNT), and the multi-layered carbon nanotube is called a multi-wall nanotube (MWNT). Particularly, a double-layered carbon nanotube is also called a double-wall nanotube (DWNT). In the conductive fiber used in the present embodiment, the carbon nanotube may be single-layered or multi-layered. However, in view of excellent conductivity and excellent thermal conductivity, a single-layered carbon nanotube is preferable.

(Step of Obtaining Fiber-Containing Crude Dispersion)

For example, the method for obtaining a crude dispersion containing the metal nanowires as fibers is not particularly limited, and the crude dispersion may be prepared by any method. It is preferable to manufacture the crude dispersion by reducing metal ions in a solvent in which a halogen compound and a dispersant have dissolved. Furthermore, after the metal nanowires are formed, from the viewpoint of dispersibility, it is preferable to perform desalination treatment by a common method. The manufacturing method of the metal nanowires is described in detail in, for example, JP2012-9219A.

It is preferable that the metal nanowires do not contain inorganic ions such as alkali metal ions, alkaline earth metal ions, and halide ions as much as possible. The electroconductivity of a dispersion obtained by dispersing the metal nanowires in an aqueous medium is preferably 1 mS/cm or less, more preferably 0.1 mS/cm or less, and even more preferably 0.05 mS/cm or less. When the electroconductivity of the dispersion is low, this means that the dispersion contains a small amount of ions as impurities. Accordingly, by measuring the conductivity of the dispersion, it is possible to ascertain the amount of ions as impurities.

The viscosity at 20° C. of an aqueous dispersion of the metal nanowires is preferably from 0.5 mPa·sec to 100 mPa·sec, and more preferably from 1 mPa·sec to 50 mPa·sec.

(Matrix)

To the crude dispersion containing the metal nanowires, a matrix can be further added to form a crude dispersion. The “matrix” is a generic term for substances that contain conductive fibers and form a layer. The matrix has a function of keeping the fibers stably dispersed. The matrix may be a non-photosensitive matrix or a photosensitive matrix.

The photosensitive matrix has an advantage that makes it easy to form a fine pattern by exposure, development, and the like.

The non-photosensitive matrix has an advantage that makes it possible to obtain a film which is apparently excellent in at least one of the conductivity, transparency, film strength, abrasion resistance, thermal resistance, moist heat resistance, and flexibility. The matrix is preferably constituted with a three-dimensional crosslinking structure containing a bond represented by the following Formula (I).

-M1-O-M1- (I)

(In Formula (I), M1 represents an element selected from a group consisting of Si, Ti, Zr, and Al.)

Examples of the matrix include a sol-gel cured substance. Preferable examples of the sol-gel cured substance include those obtained by hydrolyzing an alkoxide compound of an element selected from a group consisting of Si, Ti, Zr, and Al, performing polycondensation of the hydrolysate, and heating and drying the resultant as desired.

(Filtering Method of Crude Dispersion)

The fiber-containing crude dispersion obtained by the aforementioned method is passed through the filter medium so as to remove foreign substances. The fiber-containing crude dispersion may or may not contain the matrix.

That is, the crude dispersion may be filtered before or after the material of the matrix is added thereto.

The filter medium is constituted with a plate material having a plurality of opening portions through which the crude dispersion is passed and non-opening portions which partition the plurality of opening portions from one another. The plurality of opening portions have substantially the same shape. The shape is preferably a circle or a polygon. Alternatively, the shape is preferably slit-like. In the present specification, when a plurality of opening portions are formed by using a specific method so as to form opening portions having specific shapes, the shapes of the opening portions are regarded as being “substantially the same”. Herein, the “substantially the same” means that the shapes are the same as each other within the range of measurement errors and manufacturing errors. FIG. 2 shows the flow in which the crude dispersion is passed through the filter medium so as to remove foreign substances. A crude dispersion 20 containing the fibers 10 is retained in a tank 30, and then supplied to a filter medium 40 from the tank 30.

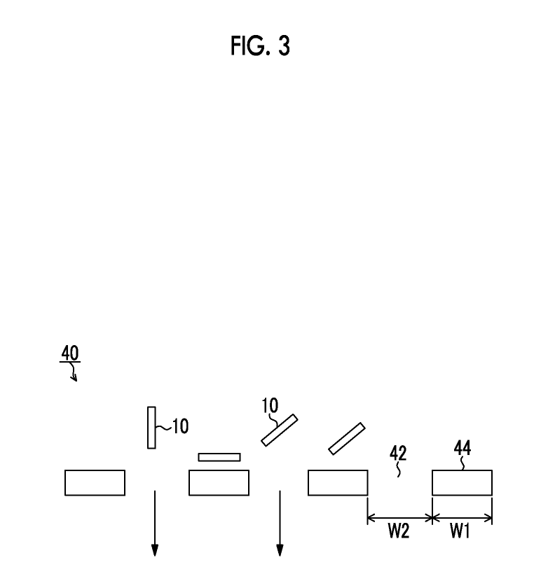

FIG. 3 is a cross-sectional view showing the relationship between the size of the filter medium 40 and the size of the fiber 10. The filter medium 40 constituted with a plate material includes opening portions 42 and non-opening portions 44. A minor-axis width W2 of each of the opening portions 42 is equal to or greater than ½ of the average major-axis length of the fibers but no greater than a length five times the average major-axis length of the fibers 10. The minor-axis width W2 of each of the opening portions 42 is preferably equal to or greater than the average major-axis length of the fibers 10 but no greater than a length three times the average major-axis length of the fibers 10. The minor-axis width W2 of each of the opening portions 42 is more preferably equal to or greater than the average major-axis length of the fibers 10 but no greater than a length two times the average major-axis length of the fibers 10.

If the minor-axis width W2 of each of the opening portions 42 is within the above range, it is possible to pass the fibers 10 through the opening portions while preventing impurities, which have to be removed, from passing through the opening portions.

A minimum width W1 of each of the non-opening portions 44 is equal to or greater than the average major-axis length of the fibers 10. The minimum width W1 of each of the opening portions 44 is preferably equal to or greater than a length two times the average major-axis length of the fibers 10, and more preferably equal to or greater than a length three times the average major-axis length of the fibers 10.

If the minimum width of each of the opening portions 44 is within the above range, it is possible to prevent the fibers 10 from straddling the non-opening portions 44 and thus being trapped in the filter medium 40.

The aperture ratio of the filter medium 40 is 0.9% or higher, preferably from 1.5% to 60%, and more preferably from 2.0% to 50%. If the aperture of the filter medium 40 is within the above range, it is possible to prevent the filtration pressure from increasing too much.

If the filter medium 40 is formed of a single-layered plate material, it is possible to inhibit the fibers 10 from being twined around the filter medium 40. The filter medium 40 can also be constituted with a plurality of single-layered plate materials. When the filter medium 40 is constituted with a plurality of single-layered plate materials, the opening portions 42 and the non-opening portions 44 preferably do not overlap each other when seen in a plan view. This is because if the opening portions 42 and the non-opening portions 44 overlap each other, the effective aperture ratio is highly likely to be extremely reduced, and pressure loss becomes great.

The filter medium 40 preferably has a strength (pressure resistance) and a thickness within a range in which the pressure loss is unproblematic for practical use.

When the crude dispersion 20 passes through the filter medium 40, the Reynolds number Re of the crude dispersion 20 is preferably 2,300 or less. The Reynolds number Re is preferably 1,500 or less, and more preferably 1,000 or less. The Reynolds number Re is set within the above range, and the crude dispersion 20 is passed through the filter medium 40 in a state of laminar flow. As a result, the fibers 10 contained in the crude dispersion 20 are oriented in the flow direction. Consequentially, the minor-axis of the fibers 10 become substantially orthogonal to the opening portions 42, whereby the fibers 10 easily pass through the opening portions 42. The Reynolds number Re is calculated by the following expression.

Re=v·d/(ν·α)

(v: average flow velocity immediately in front of filter medium (m/sec), d: diameter of filter medium-equipped pipe (m), ν: kinematic viscosity of fiber-containing crude dispersion (m²/sec), α: aperture ratio of filter medium (%))

The kinematic viscosity of the fiber-containing crude dispersion can be measured by the following method.

The kinematic viscosity is calculated by the following expression by using the density of the crude dispersion measured by a portable densimeter (manufactured by Anton Paar GmbH, DMA35N) and the absolute viscosity measured by a tuning fork-type viscometer (manufactured by A & D Company Ltd, SV-10).

Kinematic viscosity ν=(Absolute viscosity μ)/(Density ρ)

The method for calculating the Reynolds number Re will be described with reference to

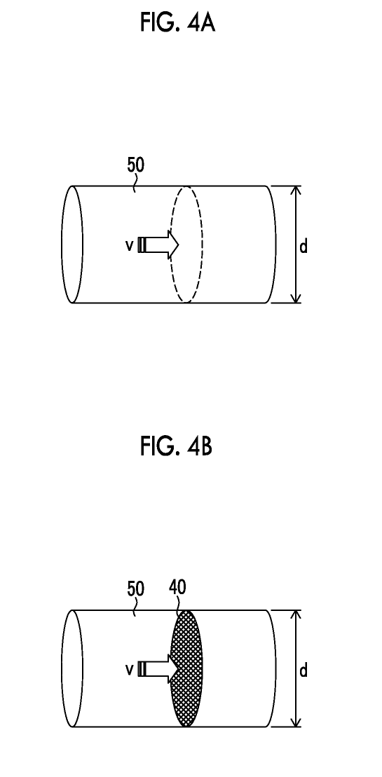

FIGS. 4A and 4B. A pipe 50 in which the filter medium 40 is to be installed has a diameter of d (m) (FIG. 4A). The average flow velocity at the time when the crude dispersion is caused to flow in the pipe 50 in which the filter medium 40 is not installed is regarded as v (m/sec). The average flow velocity v is the average flow velocity immediately in front of the filter medium. A Reynolds number Re1 of the pipe 50 is calculated as below.

Re1=v·d/ν

Next, the filter medium 40 is installed in the pipe 50, and an aperture ratio α of the filter medium 40 is calculated (FIG. 4B). The Reynolds number Re in the present embodiment is calculated by the following expression.

Reynolds number Re=Reynolds number Re1/α

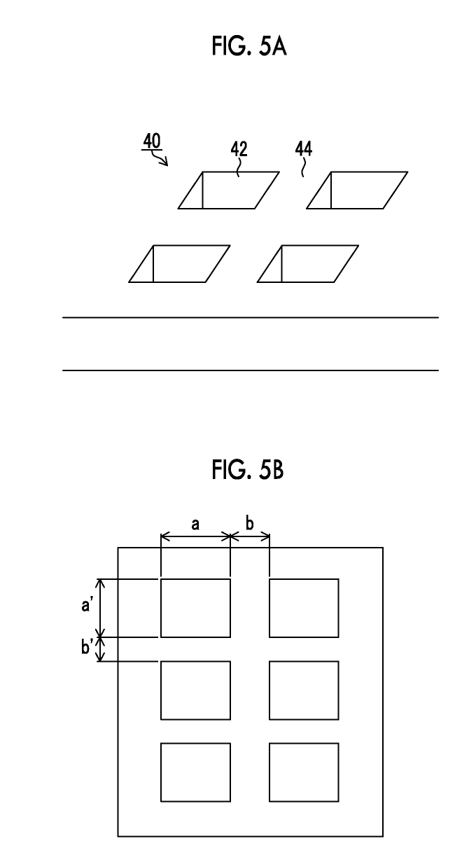

FIG. 5A is a perspective view showing a portion of the filter medium 40 having a mesh pattern. The filter medium 40 includes a plurality of opening portions 42 having substantially the same shape. In FIGS. 5A and 5B, each of the opening portions 42 has a square shape when seen in a plan view, but the shape is not limited thereto. For example, each of the opening portions 42 may be circular or polygonal. Furthermore, the opening portion 42 may be arranged in a continuous line such that they are enlarged and form a slit shape. The filter medium 40 having a mesh pattern can be manufactured by using a known electroforming technique. The filter medium 40 having a mesh pattern is constituted with a metal such as nickel or copper.

FIG. 5B is a plan view of the filter medium 40 having a mesh pattern of FIG. 5A. The aperture ratio of the filter medium 40 shown in FIG. 5B can be calculated by the following expression.

Aperture ratio=(a×a′)/((a+b)×(a′+b′))

(a: horizontal width of opening portion, a′: vertical width of opening portion, b: horizontal width of non-opening portion, b′: vertical width of non-opening portion)

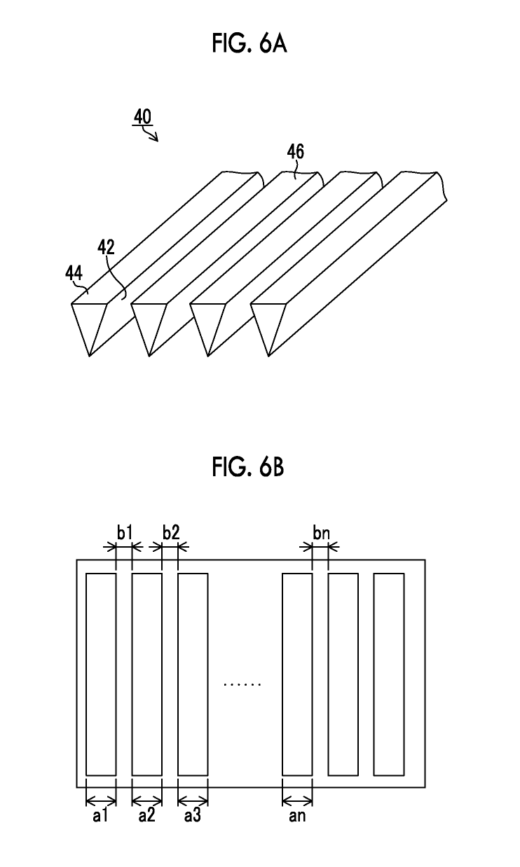

FIG. 6A is a perspective view showing a portion of the filter medium 40 constituted with a wedge wire screen. The filter medium 40 includes a plurality of wedge wires 46. Each of the opening portions 42 is constituted with wedge wires 46 adjacent to each other, and each of the non-opening portions 44 is constituted with each of the wedge wires 46. Each of the wedge wires 46 has the shape of a wedge tapered toward the downstream side from the upstream side of the flow of the crude dispersion 20. The wedge wires 46 are constituted with a metal such as SUS304 or SUS316 as stainless steel.

FIG. 6B is a plan view of the filter medium 40 constituted with the wedge wire screen. The aperture ratio of the filter medium 40 shown in FIG. 6B can be calculated by the following expression.

Aperture ratio=((Σa)/(Σa+Σb))

Σa=a1+a2+ . . . +an+ . . .

The filter medium 40 shown in FIGS. 5A, 5B, 6A, and 6B is preferably a plate material having undergone hydrophobizing treatment. If the filter medium 40 is subjected to hydrophobizing treatment, it is possible to prevent the fibers 10 from being adsorbed onto the filter medium 40. For the hydrophobizing treatment, any of coating/painting of a hydrophobic material such as Teflon (registered trademark) or a method of chemically modifying the filter medium 40 with a hydrophobic group may be used.

The relationship between the shape of the opening portions 42 and the minor-axis width of the opening portions 42 and the relationship between the shape of the non-opening portions 44 and the minimum width of the non-opening portions 44 will be described. For example, when each of the opening portions 42 or each of the non-opening portions 44 is a circle, the minor-axis width of each of the opening portions 42 or the minimum width of each of the non-opening portions 44 is regarded as a diameter of the circle. When each of the opening portions 42 or each of the non-opening portions 44 is a square or a rectangle, the minor-axis width of each of the opening portions 42 or the minimum width of each of the non-opening portions 44 is regarded as a short side. When each of the opening portions 42 or each of the non-opening portions 44 is a polygon, the maximum distance between two straight lines, which are in parallel with the maximum length of the polygon and interposing the polygon therebetween, is the minor-axis width of each of the opening portions 42 or the minimum width of each of the non-opening portions 44. The “maximum length” refers to the maximum length between any two points on the outline of each of the opening portions 42 or each of the non-opening portions 44.

The relationship between the shape of the opening portions 42 and the minor-axis width of the opening portions 42 and the relationship between the shape of the non-opening portions 44 and the minimum width of the non-opening portions 44 will be described. For example, when each of the opening portions 42 is a circle, the minor-axis width of each of the opening portions 42 becomes the diameter of the circle, and the minimum value among the values of the distance between the circle as an opening portion 42 and the circle as another opening portion 42 becomes the minimum width of each of the non-opening portions 44.

When each of the opening portions 42 is a square or a rectangle, the minor-axis width of each of the opening portions 42 becomes a short side, and the minimum value among the values of the distance between the square or the rectangle as an opening portion 42 and the square or the rectangle as another opening portion 42 becomes the minimum width of each of the non-opening portions 44.

When each of the opening portions 42 is a polygon, for calculating the minor-axis width of each of the opening portions 42, two straight lines in parallel with the longest side of the polygon is imagined, and the distance between the two straight lines are determined such that the polygon as the opening portion exactly fits in the space between the two straight lines. At this time, the distance between the two straight lines is regarded as the minor-axis width of each of the opening portions 42. Furthermore, at this time, the minimum value among the values of the distance between the polygonal opening portions 42 becomes the minimum width of each of the non-opening portions 44.

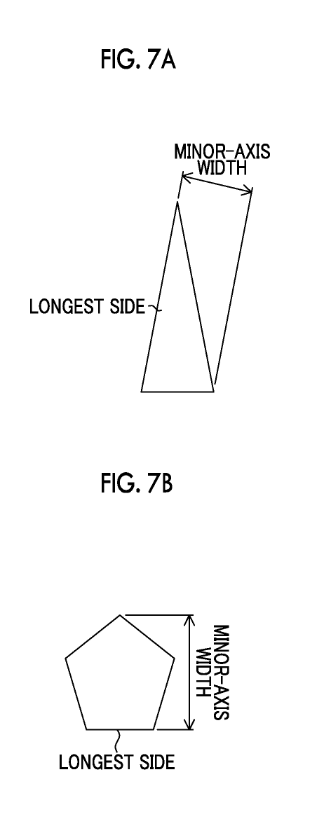

For example, when each of the opening portions is an isosceles triangle, as shown in FIG. 7A, two straight lines in parallel with the longest side (equal sides) are imagined, and the distance between the two straight lines is determined such that the isosceles triangle exactly fits in the space between the straight lines. At this time, the distance between the two straight lines becomes the minor-axis width of each of the opening portions.

Furthermore, when each of the opening portions is a pentagon, as shown in FIG. 7B, two straight lines in parallel with the longest side among five sides of the pentagon are imagined, and the distance between the two straight lines is determined such that the pentagon exactly fits in the space between the straight lines. At this time, the distance between the two straight lines becomes the minor-axis width of each of the opening portions.

(Manufacturing Method of Conductive Layer)

A conductive layer, which contains a specific sol-gel cured substance as a matrix and conductive fiber, can be obtained by preparing a coating liquid for forming a conductive layer that is obtained by adding an alkoxide compound to a conductive fiber-containing dispersion, forming a liquid film of the coating liquid by coating the coating liquid for forming a conductive layer onto a substrate, hydrolyzing the alkoxide compound in the liquid film, and forming a sol-gel cured substance by performing polycondensation of the hydrolysate. The coating liquid for forming a conductive layer is preferably prepared by mixing a dispersion of conductive fibers (for example, an aqueous solution in which silver nanowires have dispersed) with an aqueous solution containing an alkoxide compound.

### EXAMPLES

Hereinafter, the present invention will be described in more detail based on examples. However, the present invention is not limited to the examples.

### Preparation Example 1

### Preparation of Aqueous Silver Nanowire Dispersion

First, the following additive solutions A, B, C, and D were prepared.

[Additive Solution A]

60 mg of stearyl trimethyl ammonium chloride, 6.0 g of a 10% aqueous solution of stearyl trimethyl ammonium hydroxide, and 2.0 g of glucose were dissolved in 120.0 g of distilled water, thereby obtaining a reaction solution A-1. Furthermore, 70 mg of silver nitrate powder was dissolved in 2.0 g of distilled water, thereby obtaining an aqueous silver nitrate solution A-1. To the reaction solution A-1 kept at 25° C., the aqueous silver nitrate solution A-1 was added while being vigorously stirred. After the addition of the aqueous silver nitrate solution A-1, the mixture was vigorously stirred for 180 minutes, thereby obtaining an additive solution A.

[Additive Solution B]

42.0 g of silver nitrate powder was dissolved in 958.0 g of distilled water.

[Additive Solution C]

75.0 g of 25% aqueous ammonia was mixed with 925.0 g of distilled water.

[Additive Solution D]

400.0 g of polyvinylpyrrolidone (K30) was dissolved in 1.6 kg of distilled water.

Next, a silver nanowire dispersion (1) was prepared in the following manner. 1.3 g of stearyl trimethylammonium bromide powder, 33.1 g of sodium bromide powder, 1,000 g of glucose powder, and 115.0 g of nitric acid (1 N) were dissolved in 12.7 kg of distilled water at 80° C. To the resultant solution kept at 80° C., the additive solution A, the additive solution B, and the additive solution C were sequentially added at an addition rate of 250 ml/min, an addition rate of 500 ml/min, and an addition rate of 500 ml/min respectively, while being stirred at 500 rpm. The stirring speed was set to 200 rpm, and the resultant solution was heated at 80° C. After the stirring speed was set to 200 rpm, heating and stirring was continued for 100 minutes, and then the resultant solution was cooled to 25° C. The stirring speed was then changed to 500 rpm, and the additive solution D was added to the resultant solution at a rate of 500 ml/min. The obtained solution was named, a preliminary liquid 101.

Subsequently, to 1-propanol being stirred vigorously, the preliminary liquid 101 was added at a time such that the mixing ratio thereof became 1:1 in terms of a volume ratio. The obtained mixed solution was stirred for 3 minutes and named, a preliminary liquid 102.

By using an ultrafiltration module with a molecular weight cut-off of 150,000, ultrafiltration was performed as below. The preliminary liquid 102 was concentrated by 4-fold, the mixed solution consisting of distilled water and 1-propanol (1:1 in terms of a volume ratio) was then added thereto, and the resultant solution was concentrated. This process was repeated until the conductivity of the filtrate finally became 50 pS/cm or less. The obtained filtrate was concentrated, thereby obtaining an aqueous silver nanowire dispersion (1) with a metal content of 0.45%.

Regarding the silver nanowires of the aqueous silver nanowire dispersion (1), 300 silver nanowires were randomly selected from the silver nanowires to be observed under magnification by using a transmission electron microscope (TEM; manufactured by JEOL Ltd., JEM-2000FX). Thereafter, the diameter (minor-axis length) and the major-axis length of the silver nanowires were measured, and from the averages thereof, the average diameter (average minor-axis length) and the average major-axis length of the silver nanowires were obtained.

As a result, it was confirmed that the average minor-axis length of the silver nanowires was 18 nm, and the average major-axis length thereof was 8 μm.

—Preparation of Crude Coating Liquid (Crude Dispersion) for Forming Conductive Layer—

An alkoxide compound solution (hereinafter, also referred to as a “sol-gel solution”) having the following composition was stirred for 1 hour at 60° C., and then the solution was confirmed to be in the state of a uniform solution. 3.44 parts of the obtained sol-gel solution was mixed with 16.56 parts of the aqueous silver nanowire dispersion (1), and then the mixture was diluted with distilled water, thereby obtaining a coating liquid (crude dispersion) for forming a conductive layer.

As a result of measuring and calculating the coating liquid (crude dispersion) for forming a conductive layer by using a densimeter and a tuning fork-type viscometer, the kinematic viscosity was confirmed to be 5.8×10⁻⁶ (m²/sec).

<Alkoxide compound solution>

| | | |
|---|---|---|
| Tetraethoxysilane (compound (II)) | 5.0 | parts |
| (KBE-04, manufactured by Shin-Etsu Chemical Co., Ltd.) | | |
| 1% Aqueous acetic acid solution | 10.0 | parts |
| Distilled water | 4.0 | parts |

(Test 1)

The obtained coating liquid (crude dispersion) for forming a conductive layer was supplied into a filter. As a filter medium, a plate material of an electroformed mesh was used. Similarly to the filter medium shown in FIGS. 5A and 5B, this filter medium had square openings. The horizontal width and the vertical width of each of the opening portions were 5 μm, and this was the minor-axis width of each of the opening portions. The horizontal width and the vertical width of each of the non-opening portions were 10 μm, and this was the minimum width of each of the non-opening portions. Furthermore, when the horizontal width and the vertical width of each of the non-opening portions were different from each other, the smaller width became the minimum width of each of the non-opening portions. The aperture ratio was calculated based on the expression described with reference to FIG. 5B. The aperture ratio was 11.1%. The average flow velocity immediately in front of the filter medium was 2 (mm/sec); the diameter of the filter medium-equipped pipe was 0.022 m; the kinematic viscosity of the fiber-containing crude dispersion was 5.8×10⁻⁶ (m²/sec); and the Reynolds number Re was 68. The filter medium was not subjected to hydrophobizing treatment. 1,000 mL of the crude coating liquid (crude dispersion) for forming a conductive layer was filtered under the aforementioned conditions, thereby obtaining a coating liquid (dispersion) for forming a conductive layer.

(Tests 2 to 13)

In the same manner as in Test 1, the obtained crude coating liquid (crude dispersion) for forming a conductive layer was supplied to a filter using a plate material of an electroformed mesh as a filter medium, thereby obtaining coating liquids (dispersions) for forming a conductive layer of Tests 2 to 13. In Tests 2 to 13, the filter medium and the conditions including the Reynolds number Re and the like are as shown in Table 1.

(Test 14)

The obtained crude coating liquid (crude dispersion) for forming a conductive layer was supplied to a filter. Instead of the plate material of an electroformed mesh, a plate material constituted with a wedge wire screen was used as a filter medium. Similarly to the filter medium shown in FIGS. 6A and 6B, the filter medium had slit-like opening portions. The minor-axis width of each of the opening portions was 5 μm; the minor-axis width of the n-th opening portion was 5 μm (all of the opening portions had a minor-axis width of 5 μm); the horizontal width (minimum width) of each of the non-opening portions was 500 μm; and the horizontal width (minimum width) of the n-th non-opening portion was 500 μm (all of the non-opening portions had a minimum width of 500 μm). The aperture ratio was calculated based on the expression described in FIG. 6B. The aperture ratio was 0.99%. The average flow velocity immediately in front of the filter medium was 2 (mm/sec); the diameter of the filter medium-equipped pipe was 0.022 m; the kinematic viscosity of the fiber-containing crude dispersion was 5.8×10⁻⁶ (m²/sec); and the Reynolds number Re was 758. The filter medium was not subjected to hydrophobizing treatment. 1,000 mL of the coating liquid (crude dispersion) for forming a conductive layer was filtered under the aforementioned conditions, thereby obtaining a coating liquid (dispersion) for forming a conductive layer.

(Tests 15 to 23)

In the same manner as in Test 14, the obtained coating liquid (crude dispersion) for forming a conductive layer was supplied to a filter using a plate material constituted with a wedge wire screen as a filter medium, thereby obtaining coating liquids (dispersions) for forming a conductive layer of Tests 15 to 23. In Tests 15 to 23, the filter medium and the conditions including the Re number and the like are as shown in Table 2.

Herein, regarding Tests 18 and 22, in some cases, the horizontal width of any n-th non-opening portion was 1,000 μm, and there was a plurality of sites at which the horizontal width of each of the non-opening portions was 1,000 μm. Accordingly, the number of the sites of the non-opening portion having a horizontal width of 500 μm and the number of the sites of the non-opening portion having a horizontal width of 1,000 μm were determined such that the aperture ratio became 1.00% and 0.50% respectively. In Test 18, among 50 sites of the non-opening portions, the non-opening portion at one site had a horizontal width of 500 μm, and the non-opening portions at 49 sites had a horizontal width of 1,000 μm. In Test 22, among 100 sites of the non-opening portions, the non-opening portion at one site had a horizontal width of 500 μm, and the non-opening portions at 99 sites had a horizontal width of 1,000 μm.

(Tests 24 and 25)

The obtained crude coating liquid (crude dispersion) for forming a conductive layer was supplied to a filter using a sheet filter made of non-woven cloth as a filter medium, thereby obtaining coating liquids (dispersions) for forming a conductive layer of Tests 24 and 25. As the sheet filter, the FNC filter manufactured by MAHLE COM. was used. In Tests 24 and 25, the filter medium and the conditions including the Reynolds number Re and the like are as shown in Table 2.

Each of the obtained coating liquids for forming a conductive layer of Tests 1 to 25 was measured in the following manner, in terms of the change in filtration pressure of the start point and endpoint of filtration, a reduction rate of silver concentration before and after filtration, and the number of foreign substances in the liquid. The coating liquids were evaluated based on the following criteria, and the results were shown in Tables 1 and 2.

(Change in Filtration Pressure)

The pressure of the primary side of the filter in the process of filtration was measured. From the change in the filtration pressure from the start point of filtration to the endpoint of the filtration, the difference was measured and ranked as below.
Rank A: Pressure change is less than 0.03 MPa, which is an excellent level.
Rank B: Pressure change is 0.03 MPa or more but less than 0.1 MPa, which is a fine level.
Rank C: Pressure change is 0.1 MPa or more, which is a problematic level for practical use.

(Reduction Ratio of Silver Concentration)

Each of the crude coating liquid for forming a conductive layer that had not yet been filtered and the coating liquid for forming a conductive layer that had been filtered was diluted by 5-fold by being supplemented with a P2 diluent shown below. After silver was dissolved in each of the obtained diluents, each of the resultant solutions was further diluted with pure water by 10-fold, thereby preparing silver nanowire solutions respectively. By using an ICP emission spectrometer, the amount of silver in each of the silver nanowire solutions was measured, and the reduction rate thereof was calculated.

The method for preparing the P2 diluent is described below.

Bleach-fixing solution (manufactured by FUJIFILM Corporation, CP-48S-P2-A and CP-48S-P2-B) for treating color paper were mixed with pure water at the following ratio, thereby obtaining the P2 diluent.

(P2 diluent)

| | |
|---|---|
| CP-48S-P2-A | 17.4 (% by mass) |
| CP-48S-P2-B | 21.4 (% by mass) |
| Pure water | 61.2 (% by mass) |

The amount of silver in the coating liquids for forming a conductive layer before and after the filtration was measured by the aforementioned method. According to the results, the coating liquids were ranked as below.
Rank A: The reduction rate of silver concentration is 2% or less, which is an excellent level.
Rank B: The reduction rate of silver concentration is higher than 2% but 5% or less, which is a fine level.
Rank C: The reduction rate of silver concentration is higher than 5%, which is a problematic level for practical use.

(Number of Foreign Substances in Liquid)

The coating liquids for forming a conductive layer that had been filtered were measured by using an image analysis-type particle size distribution analyzer (FPIA2100 manufactured by Malvern Instruments), and the number of foreign substances in 1 μL of the coating liquids was counted. This process was performed 10 times. In this manner, the average thereof was determined, and the coating liquids were ranked as below. Here, in the present embodiment, the conductive fiber is defined as “a conductive particle having a minor-axis length of 1 nm to 150 nm and having a major-axis length of 1 μm to 30 μm”, and the foreign substance is defined as a solid content that does not correspond to the conductive fiber.
Rank A: The number of foreign substances is less than 0.1, which is an excellent level.
Rank B: The number of foreign substances is 0.1 or greater but less than 5, which is a fine level.
Rank C: The number of foreign substances is 5 or greater, which is a problematic level for practical use.

TABLE 1

| | | | | | Horizontal | | | | |
|---|---|---|---|---|---|---|---|---|---|
| | | | | | width of | | | | |
| | | | | | opening | Horizontal | Vertical | | |
| | | | | | portion = | width | width | | |
| | | | | | vertical width | b of | b′ of | Aperture | |
| | | | Shape | Average | of opening | non- | non- | ratio | |
| | | | of | major-axis | portion | opening | opening | of filter | |
| | Filter | | opening | length | a = a′ | portion | portion | medium | Re- |
| | medium | Structure | portion | of fiber | (μm) | (μm) | (μm) | (%) | number |
| Test | Electroformed | Plate | Square | 8 | 5 | 10 | 10 | 11.1 | 68 |
| 1 | mesh | material | | | | | | | |
| Test | Electroformed | Plate | Square | 8 | 10 | 10 | 10 | 25 | 30 |
| 2 | mesh | material | | | | | | | |
| Test | Electroformed | Plate | Square | 8 | 20 | 10 | 10 | 44.4 | 17 |
| 3 | mesh | material | | | | | | | |
| Test | Electroformed | Plate | Square | 8 | 40 | 10 | 10 | 64 | 12 |
| 4 | mesh | material | | | | | | | |
| Test | Electroformed | Plate | Square | 8 | 10 | 20 | 20 | 11.1 | 68 |
| 5 | mesh | material | | | | | | | |
| Test | Electroformed | Plate | Square | 8 | 10 | 10 | 300 | 1.6 | 474 |
| 6 | mesh | material | | | | | | | |
| Test | Electroformed | Plate | Square | 8 | 10 | 10 | 10 | 25 | 1517 |
| 7 | mesh | material | | | | | | | |
| Test | Electroformed | Plate | Square | 8 | 5 | 10 | 10 | 11.1 | 68 |
| 8 | mesh | material | | | | | | | |
| Test | Electroformed | Plate | Square | 8 | 1 | 10 | 10 | 0.8 | 948 |
| 9 | mesh | material | | | | | | | |
| Test | Electroformed | Plate | Square | 8 | 80 | 10 | 10 | 79 | 9.6 |
| 10 | mesh | material | | | | | | | |
| Test | Electroformed | Plate | Square | 8 | 10 | 5 | 5 | 44.4 | 17 |
| 11 | mesh | material | | | | | | | |
| Test | Electroformed | Plate | Square | 8 | 10 | 10 | 650 | 0.76 | 998 |
| 12 | mesh | material | | | | | | | |
| Test | Electroformed | Plate | Square | 8 | 10 | 10 | 10 | 25 | 3034 |
| 13 | mesh | material | | | | | | | |

| | Average | | | | | | |
|---|---|---|---|---|---|---|---|
| | flow | | Kinematic | | | | |
| | velocity | Diameter | viscosity of | | | | |
| | immediately | of filter | fiber- | | | | Number |
| | in front | medium- | containing | Hydrophobizing | | Reduction | of |
| | of filter | equipped | crude | treatment | Change in | rate of | foreign |
| | medium | pipe | dispersion | of filter | filtration | silver | substances |
| | (mm/sec) | (m) | (m²/sec) | medium | pressure | concentration | in liquid |
| Test | 2 | 0.022 | 5.8 × 10⁻⁶ | Not | B | B | A |
| 1 | | | | performed | | | |
| Test | 2 | 0.022 | 5.8 × 10⁻⁶ | Not | A | A | A |
| 2 | | | | performed | | | |
| Test | 2 | 0.022 | 5.8 × 10⁻⁶ | Not | A | A | B |
| 3 | | | | performed | | | |
| Test | 2 | 0.022 | 5.8 × 10⁻⁶ | Not | A | A | B |
| 4 | | | | performed | | | |
| Test | 2 | 0.022 | 5.8 × 10⁻⁶ | Not | A | A | A |
| 5 | | | | performed | | | |
| Test | 2 | 0.022 | 5.8 × 10⁻⁶ | Not | B | A | A |
| 6 | | | | performed | | | |
| Test | 100 | 0.022 | 5.8 × 10⁻⁶ | Not | B | B | A |
| 7 | | | | performed | | | |
| Test | 2 | 0.022 | 5.8 × 10⁻⁶ | Performed | A | A | A |
| 8 | | | | | | | |
| Test | 2 | 0.022 | 5.8 × 10⁻⁶ | Not | C | C | A |
| 9 | | | | performed | | | |
| Test | 2 | 0.022 | 5.8 × 10⁻⁶ | Not | A | A | C |
| 10 | | | | performed | | | |
| Test | 2 | 0.022 | 5.8 × 10⁻⁶ | Not | A | C | A |
| 11 | | | | performed | | | |
| Test | 2 | 0.022 | 5.8 × 10⁻⁶ | Not | C | A | A |
| 12 | | | | performed | | | |
| Test | 200 | 0.022 | 5.8 × 10⁻⁶ | Not | B | B | A |
| 13 | | | | performed | | | |

TABLE 2

| | | | | | | Horizontal | | Horizontal | |
|---|---|---|---|---|---|---|---|---|---|
| | | | | | Minor-axis | width | Minor-axis | width | |
| | | | | | width a₁ | b₁ of | width aₙ | bₙ of n-th | Aperture |
| | | | Shape | Average | of | non- | of n-th | non- | ratio of |
| | | | of | major-axis | opening | opening | opening | opening | filter |
| | Filter | | opening | length of | portion | portion | portion | portion | medium |
| | medium | Structure | portion | fiber | (μm) | (μm) | (μm) | (μm) | (%) |
| Test | Wedge | Plate | Slit | 8 | 5 | 500 | 5 | 500 | 0.99 |
| 14 | wire | material | | | | | | | |
| | screen | | | | | | | | |
| Test | Wedge | Plate | Slit | 8 | 10 | 500 | 10 | 500 | 1.96 |
| 15 | wire | material | | | | | | | |
| | screen | | | | | | | | |
| Test | Wedge | Plate | Slit | 8 | 20 | 500 | 20 | 500 | 3.85 |
| 16 | wire | material | | | | | | | |
| | screen | | | | | | | | |
| Test | Wedge | Plate | Slit | 8 | 40 | 500 | 40 | 500 | 7.41 |
| 17 | wire | material | | | | | | | |
| | screen | | | | | | | | |
| Test | Wedge | Plate | Slit | 8 | 10 | 500 | 10 | 1000 | 1.00 |
| 18 | wire | material | | | | | | | |
| | screen | | | | | | | | |
| Test | Wedge | Plate | Slit | 8 | 10 | 500 | 10 | 500 | 1.96 |
| 19 | wire | material | | | | | | | |
| | screen | | | | | | | | |
| Test | Wedge | Plate | Slit | 8 | 5 | 500 | 5 | 500 | 0.99 |
| 20 | wire | material | | | | | | | |
| | screen | | | | | | | | |
| Test | Wedge | Plate | Slit | 8 | 80 | 500 | 80 | 500 | 13.79 |
| 21 | wire | material | | | | | | | |
| | screen | | | | | | | | |
| Test | Wedge | Plate | Slit | 8 | 5 | 500 | 10 | 1000 | 0.50 |
| 22 | wire | material | | | | | | | |
| | screen | | | | | | | | |
| Test | Wedge | Plate | Slit | 8 | 10 | 500 | 10 | 500 | 1.96 |
| 23 | wire | material | | | | | | | |
| | screen | | | | | | | | |
| Test | Sheet | Non-woven | Random | 8 | 10 | 5 | — | — | Approximately |
| 24 | filter | cloth | | | | | | | 20 |
| Test | Sheet | Non-woven | Random | 8 | 40 | 5 | — | — | Approximately |
| 25 | filter | cloth | | | | | | | 30 |

| | | Average | | Kinematic | | | | |
|---|---|---|---|---|---|---|---|---|
| | | flow | | viscosity | | | | |
| | | velocity | Diameter | of | | | | |
| | | immediately | of filter | fiber- | | | | |
| | | in front | medium- | containing | Hydrophobizing | Change | Reduction | Number of |
| | | of filter | equipped | crude | treatment | in | rate of | foreign |
| | Re- | medium | pipe | dispersion | of filter | filtration | silver | substances |
| | number | (mm/sec) | (m) | (m²/sec) | medium | pressure | concentration | in liquid |
| Test | 758 | 2 | 0.022 | 5.8 × 10⁻⁶ | Not | B | B | A |
| 14 | | | | | performed | | | |
| Test | 379 | 2 | 0.022 | 5.8 × 10⁻⁶ | Not | A | A | A |
| 15 | | | | | performed | | | |
| Test | 200 | 2 | 0.022 | 5.8 × 10⁻⁶ | Not | A | A | B |
| 16 | | | | | performed | | | |
| Test | 103 | 2 | 0.022 | 5.8 × 10⁻⁶ | Not | A | A | B |
| 17 | | | | | performed | | | |
| Test | 759 | 2 | 0.022 | 5.8 × 10⁻⁶ | Not | B | A | A |
| 18 | | | | | performed | | | |
| Test | 1897 | 10 | 0.022 | 5.8 × 10⁻⁶ | Not | B | B | A |
| 19 | | | | | performed | | | |
| Test | 758 | 2 | 0.022 | 5.8 × 10⁻⁶ | Performed | A | A | A |
| 20 | | | | | | | | |
| Test | 55 | 2 | 0.022 | 5.8 × 10⁻⁶ | Not | A | A | C |
| 21 | | | | | performed | | | |
| Test | 1517 | 2 | 0.022 | 5.8 × 10⁻⁶ | Not | C | B | A |
| 22 | | | | | performed | | | |
| Test | 3793 | 20 | 0.022 | 5.8 × 10⁻⁶ | Not | B | B | A |
| 23 | | | | | performed | | | |
| Test | 38 | 2 | 0.022 | 5.8 × 10⁻⁶ | Not | C | C | B |
| 24 | | | | | performed | | | |
| Test | 25 | 2 | 0.022 | 5.8 × 10⁻⁶ | Not | B | C | C |
| 25 | | | | | performed | | | |

<Comprehensive Evaluation>

As shown in Table 1, Tests 1 to 8 and 13 satisfy the conditions of (1) ½ of average major-axis length of fibers≦Minor-axis width of opening portions≦5 times the average major-axis length of fibers, (2) Minimum width of non-opening portions≧Average major-axis length of fibers, and (3) Aperture ratio of filter medium≧0.9%. Accordingly, in terms of the respective evaluation items, Tests 1 to 8 and 13 were ranked a level equal to or higher than B. Furthermore, the smaller the minor-axis width of the opening portions, the better the evaluation result of the number of foreign substances in liquid. Moreover, when the minor-axis width of the opening portions was no greater than a length 2 times the average major-axis length of the fiber, the coating liquids were ranked A in the evaluation of the number of foreign substances in liquid. In contrast, Test 1, in which the minor-axis width of the opening portions was smaller than the average major-axis length of the fiber, was ranked B in the evaluation of the change in filtration pressure and the reduction rate of silver concentration.

In addition, regarding the aperture ratio, the higher the aperture ratio, the better the evaluation results of the change in filtration pressure and the reduction rate of silver concentration. In contrast, the higher the aperture ratio, the worse the evaluation result of the number of foreign substances in liquid. There is a trade-off relationship between the change in filtration pressure as well as reduction rate of silver concentration and the number of foreign substances in liquid.

Among Tests 1 to 8 and 13, Tests 2, 5, and 8 were ranked A in terms of all of the evaluation items. In Test 8, the filter medium was subjected to hydrophobizing treatment unlike in Test 1, and this is the only difference between Test 1 and Test 8. Test 8, in which the filter medium was subjected to hydrophobizing treatment, obtained better results compared to Test 1, in the evaluation of the change in filtration pressure and the reduction rate of silver concentration.

Next, the Reynolds number Re is the only difference among Test 2, Test 7, and Test 13. Regarding the Reynolds number Re, the smaller the Reynolds number Re, particularly, when the Reynolds number Re was 1,000 or less, the better the results obtained in the evaluation of the change in filtration pressure and the reduction rate of silver concentration.

Meanwhile, in Test 9, the minor-axis width of the opening portions was less than ½ of the average major-axis length of the fiber, and the aperture ratio was lower than 0.9%. Therefore, Test 9 was ranked C in the evaluation of the change in filtration pressure and the reduction rate of silver concentration. In Test 10, the minor-axis width of the opening portions was greater than a length 5 times the average major-axis length of the fiber. Accordingly, Test 10 was ranked C in the evaluation of the number of foreign substances in liquid. In Test 11, the width (minimum width) of the non-opening portions was smaller than the average major-axis length of the fiber. Accordingly, Test 11 was ranked C in the evaluation of the reduction rate of silver concentration. In Test 12, the aperture ratio was lower than 0.9%. Consequently, Test 12 was ranked C in the evaluation of the change in filtration pressure.

As shown in Table 2, Tests 14 to 20 and 23 satisfy the conditions of (1) ½ of average major-axis length of fiber≦Minor-axis width of opening portions≦5 times the average major-axis length of fibers, (2) Minimum width of non-opening portions≧Average major-axis length of fibers, and (3) Aperture ratio of filter medium≧0.9%. Accordingly, in the respective evaluation items, Tests 14 to 20 and 23 were ranked a level equal to or higher than B. Furthermore, the smaller the minor-axis width of the opening portions, the better the evaluation result of the number of foreign substances in liquid. Moreover, when the minor-axis width of the opening portions was no greater than a length 2 times the average major-axis length of the fiber, the coating liquids were ranked A in the evaluation of the number of foreign substances in liquid. In contrast, Test 14, in which the minor-axis width of the opening portions was smaller than the average major-axis length of the fiber, was ranked B in the evaluation of the change in filtration pressure and the reduction rate of silver concentration.

In addition, regarding the aperture ratio, the higher the aperture ratio, the better the evaluation results of the change in filtration pressure and the reduction rate of silver concentration. In contrast, the higher the aperture ratio, the worse the evaluation result of the number of foreign substances in liquid. There is a trade-off relationship between the change in filtration pressure as well as reduction rate of silver concentration and the number of foreign substances in liquid.

Among Tests 14 to 20 and 23, Test 15 and Test 20 were ranked A in terms of all of the evaluation items.

Meanwhile, as shown in Table 2, the minor-axis width of the opening portions in Test 21 was greater than a length 5 times the average major-axis length of the fiber. Accordingly, Test 21 was ranked C in the evaluation of the number of foreign substances in liquid. In Test 22, the aperture ratio was lower than 0.9%. Therefore, Test 22 was ranked C in the evaluation of the change in filtration pressure.

In Test 20, the filter medium was subjected to hydrophobizing treatment unlike in Test 14, and this is the only difference between Test 14 and Test 20. Test 20, in which the filter medium was subjected to hydrophobizing treatment, obtained better results compared to Test 14, in the evaluation of the change in filtration pressure and the reduction rate of silver concentration.

Next, the Reynolds number Re is the only difference among Test 15, Test 19, and Test 23. Regarding the Reynolds number Re, the smaller the Reynolds number Re, particularly, when the Reynolds number Re was 1,000 or less, the better the results obtained in the evaluation of the change in filtration pressure and the reduction rate of silver concentration.

As shown in Table 2, in Tests 24 and 25, a sheet filter was used. Test 24 was ranked C in the evaluation of the change in filtration pressure and the reduction rate of silver concentration. Test 25 was ranked C in the evaluation of the reduction rate of silver concentration and the number of foreign substances in liquid.

What is claimed is:

1. A manufacturing method of a fiber-containing dispersion, comprising:
obtaining a fiber-containing crude dispersion; and
removing foreign substances by passing the crude dispersion through a filter medium,
wherein the filter medium is constituted with a plate material having a plurality of opening portions through which the crude dispersion is passed and non-opening portions which partition the plurality of opening portions from one another, and satisfies the following relational expressions.
½ of average major-axis length of fibers≦Minor-axis width of opening portions≦5 times the average major-axis length of fibers
Minimum width of non-opening portions≧Average major-axis length of fibers
Aperture ratio of filter medium≧0.9%

2. The manufacturing method of a fiber-containing dispersion according to claim 1,
wherein in the removing, the Reynolds number Re of the crude dispersion calculated by the following expression is 2,300 or less.
Re=v·d/(ν·α)
v: Average flow velocity immediately in front of filter medium (m/sec)
d: Diameter of filter medium-equipped pipe (m)
ν: Kinematic viscosity of fiber-containing crude dispersion (m²/sec)
α: Aperture ratio of filter medium (%)

3. The manufacturing method of a fiber-containing dispersion according to claim 1,
wherein the plate material is constituted with a plate material having a single-layer structure.

4. The manufacturing method of a fiber-containing dispersion according to claim 2,
wherein the plate material is constituted with a plate material having a single-layer structure.

5. The manufacturing method of a fiber-containing dispersion according to claim 3,
wherein the plurality of opening portions have substantially the same shape, and the shape is a circle or a polygon.

6. The manufacturing method of a fiber-containing dispersion according to claim 4,
wherein the plurality of opening portions have substantially the same shape, and the shape is preferably a circle or a polygon.

7. The manufacturing method of a fiber-containing dispersion according to claim 5,
wherein the filter medium is a filter medium formed by an electroforming process.

8. The manufacturing method of a fiber-containing dispersion according to claim 6,
wherein the filter medium is a filter medium formed by an electroforming process.

9. The manufacturing method of a fiber-containing dispersion according to claim 3,
wherein the plurality of opening portions have substantially the same shape, and the shape is slit-like.

10. The manufacturing method of a fiber-containing dispersion according to claim 4,
wherein the plurality of opening portions have substantially the same shape, and the shape is preferably slit-like.

11. The manufacturing method of a fiber-containing dispersion according to claim 9,
wherein the filter medium is a wedge wire screen.

12. The manufacturing method of a fiber-containing dispersion according to claim 10,
wherein the filter medium is a wedge wire screen.

13. The manufacturing method of a fiber-containing dispersion according to claim 1,
wherein the fiber is a silver nanowire.

14. The manufacturing method of a fiber-containing dispersion according to claim 13,
wherein the crude dispersion is an aqueous silver nanowire dispersion obtained by dispersing silver nanowires in an aqueous solvent.

15. The manufacturing method of a fiber-containing dispersion according to claim 1,
wherein the filter medium is constituted with a plate material having undergone hydrophobizing treatment.

16. A conductive fiber-containing dispersion obtained by the manufacturing method of a fiber-containing dispersion according to claim 1,
wherein the number of foreign substances contained in the dispersion is less than 0.1 per 1 μL.

17. A manufacturing method of a conductive layer, comprising:
coating the conductive fiber-containing dispersion according to claim 16 onto a substrate; and
drying the dispersion.

18. The manufacturing method of a fiber-containing dispersion according to claim 1,
wherein the fiber is a metal nanowire, a metal nanotube, and/or a carbon nanotube.
